(19) United States
(12) Patent Application Publication
(10) Pub. No.: US 2025/0227049 A1
(43) Pub. Date: Jul. 10, 2025

(54) MEMORY EXPANSION FABRIC FOR NETWORKED COMMUNICATION WITH APPLICATION TO VIRTUALIZED SERVERS

(71) Applicant: Micron Technology, Inc., Boise, ID (US)

(72) Inventors: Craig Warner, Boise, ID (US); David A. Roberts, Boise, ID (US)

(73) Assignee: Micron Technology, Inc., Boise, ID (US)

(21) Appl. No.: 18/988,497

(22) Filed: Dec. 19, 2024

Related U.S. Application Data
(60) Provisional application No. 63/619,058, filed on Jan. 9, 2024.

(51) Int. Cl. H04L 43/20; H04L 41/40; H04L 49/901

(52) U.S. Cl. CPC H04L 43/20; H04L 41/40; H04L 49/901

(57) ABSTRACT

A method of transmitting a data packet from a first virtualized server to a second virtualized server includes copying, by the first virtualized server, the data packet into a send queue associated with the first virtualized server, where the send queue is located at a fabric attached memory, where the fabric attached memory is accessible by the first virtualized server and the second virtualized server. The method further includes retrieving, by one or more processors associated with the fabric attached memory, the data packet from the send queue and forwarding, by the one or more processors, the data packet to a receive queue associated with the second virtualized server, where the receive queue is located at the fabric attached memory. The method further includes retrieving, by the second virtualized server, the data packet from the receive queue.

### CROSS-REFERENCE TO RELATED APPLICATIONS

This application claims the filing benefit of U.S. Provisional Application No. 63/619,058, filed Jan. 9, 2024. This application is incorporated by reference herein in its entirety and for all purposes.

### BACKGROUND

Network communication between operating systems (OS), such as virtual machines (VM) and/or containers may be resource and/or cost intensive. For example, traditional networking switches, Network Interface Cards (NICs), and/or networking cables may generally be used to allow each OS to make networking requests. Further, where each OS is not able to interface directly with switching hardware, highly virtualized servers may experience bottlenecks from the primary OS running on each server, reducing efficiency of such servers and data centers utilizing such servers.

### SUMMARY

A method of transmitting a data packet from a first virtualized server to a second virtualized server is disclosed herein. The method includes copying, by the first virtualized server, the data packet into a send queue associated with the first virtualized server, where the send queue is located at a fabric attached memory, where the fabric attached memory is accessible by the first virtualized server and the second virtualized server. The method further includes retrieving, by one or more processors associated with the fabric attached memory, the data packet from the send queue and forwarding, by the one or more processors, the data packet to a receive queue associated with the second virtualized server, where the receive queue is located at the fabric attached memory. The method further includes retrieving, by the second virtualized server, the data packet from the receive queue.

A fabric attached memory controller disclosed herein interfaces with a compute express link (CXL) switched memory fabric and at least a first virtualized server and a second virtualized server in communication with the CXL switched memory fabric. The fabric attached memory controller includes a packet forwarding arbiter configured to monitor a send queue associated with the first virtualized server at a global fabric attached memory (GFAM) location to determine that the send queue contains a packet to be sent to the second virtualized server. The fabric attached memory controller further includes packet forwarding intelligence configured to utilize stored information about the second virtualized server to forward the packet to a receive queue associated with the second virtualized server at the GFAM location.

A data center disclosed herein includes a fabric attached memory and a first virtualized server located at a first physical host, where the first virtualized server is configured to copy a data packet into a send queue associated with the first virtualized server, where the send queue is located at the fabric attached memory. The data center further includes one or more processors associated with the fabric attached memory, where the one or more processors are configured to retrieve the data packet from the send queue and to forward the data packet to a receive queue at the fabric attached memory. The data center further includes a second virtualized server located at a second physical host and associated with the receive queue, where the second virtualized server is configured to retrieve the data packet from the receive queue.

Additional embodiments and features are set forth in part in the description that follows and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example system topography for networked communication of virtualized servers, in accordance with various embodiments of the disclosure.

FIG. 2 illustrates an example fabric attached memory (FAM) controller and associated memory, in accordance with various embodiments of the disclosure.

FIG. 3 illustrates an example system topography for networked communication of virtualized servers with capabilities for bridging to remote servers, in accordance with various embodiments of the disclosure.

FIG. 4 illustrates an example method for networked communication between virtualized servers, in accordance with various embodiments of the disclosure.

FIG. 5 illustrates example operations for a virtualized server to send a data packet using networked communication techniques described herein.

FIG. 6 illustrates example operations for a virtualized server to receive a data packet using networked communication techniques described herein.

### DETAILED DESCRIPTION

Traditional networking in data centers and other servers generally requires each server in a rack to have a connection to an Ethernet or other switch at the top of the rack, which provides communication between the servers. Fabric attached memory (FAM) may be utilized in data centers to enable sharing of memory at the top of the rack between multiple servers. Implementation of FAM may utilize memory pipes between servers and the memory at the top of the rack. Systems and methods described herein may generally utilize the memory pipes used to implement FAM structure for traditional networking, allowing for intra-rack communication between servers without an additional Ethernet or other networking cable to interconnect with the top of rack switch.

Systems described herein may include send and receive queues on a shared memory device, allowing operating systems (OSs) on servers within a rack to write data directly to send queues and retrieve data directly from receive queues. Such OSs may be hosted on containers, virtual machines (VMs), and/or other types of virtualized platforms. The systems described herein may allow for more OSs to be implemented on a single server, due to various limitations of traditional networking protocols, such as peripheral component interconnect express (PCIe) protocols. For example PCIe protocols may limit the number of VMs with a hard cap. The systems described herein may further utilize a page protection system such that each container uses a page to interface with the communication system, bypassing traditional virtual function limitations. Utilizing shared memory for intra-rack communication may further be accomplished without headers on each packet used in traditional networking protocols. Accordingly, the systems and methods described herein may provide simplified methods of intra-rack communications when compared to traditional networking protocols, as well as allowing for more OSs to be housed on individual servers when compared to servers using traditional networking protocols.

Systems and methods described herein may generally use memory interconnect protocols like the Compute Express Link (CXL) protocol supporting Global Fabric Attached Memory (GFAM) devices and hardware mechanisms inside of a memory controller. Low-cost, low-latency, highly scalable, operating system to operating system (OS-to-OS) networking may be implemented using the memory switching fabric and GFAM access semantics. For example, the systems described herein may utilize a memory expansion or disaggregation network as an alternate path and utilize additional ports (e.g., providing an increased radix) to expand reach of a network, or reduce the number of dedicated network ports and switches required. Memory controller logic provided in the disclosed system may further incorporate network packet switching and routing capability, allowing for the low-cost, low-latency, scalable OS-to-OS networking described herein.

In various examples, a memory system used herein may be a CXL compliant memory system (e.g., the memory system can include a PCIe/CXL interface). CXL is a high-speed central processing unit (CPU)-to-device and CPU-to-memory interconnect designed to accelerate next-generation data center performance. CXL technology maintains memory coherency between the CPU memory space and memory on attached devices, which allows resource sharing for higher performance, reduced software stack complexity, and lower overall system cost.

CXL is generally designed to be an industry open standard interface for high-speed communications, as accelerators are increasingly used to complement CPUs in support of emerging applications such as artificial intelligence and machine learning. CXL technology is built on the peripheral component interconnect express (PCIe) infrastructure, leveraging PCIe physical and electrical interfaces to provide advanced protocol in areas such as input/output (I/O) protocol, memory protocol (e.g., initially allowing a host to share memory with an accelerator), and coherency interface. In some examples, the CXL technology can include a plurality of I/O lanes configured to transfer the plurality of commands to or from circuitry external to the memory controller at a rate of around thirty-two (32) giga-transfers per second. In another example, the CXL technology can comprise a PCIe 5.0 interface coupled to a plurality of I/O lands, wherein the memory controller is to receive commands involving at least one of a memory device, a second memory device, or any combination thereof, via the PCIe 5.0 interface according to a compute express link memory system.

While the systems herein are generally described as utilizing the CXL protocol, other memory protocols such as Gen-Z hardware management console (HMC), RapidIP, OpenCAPI, among others, may be utilized.

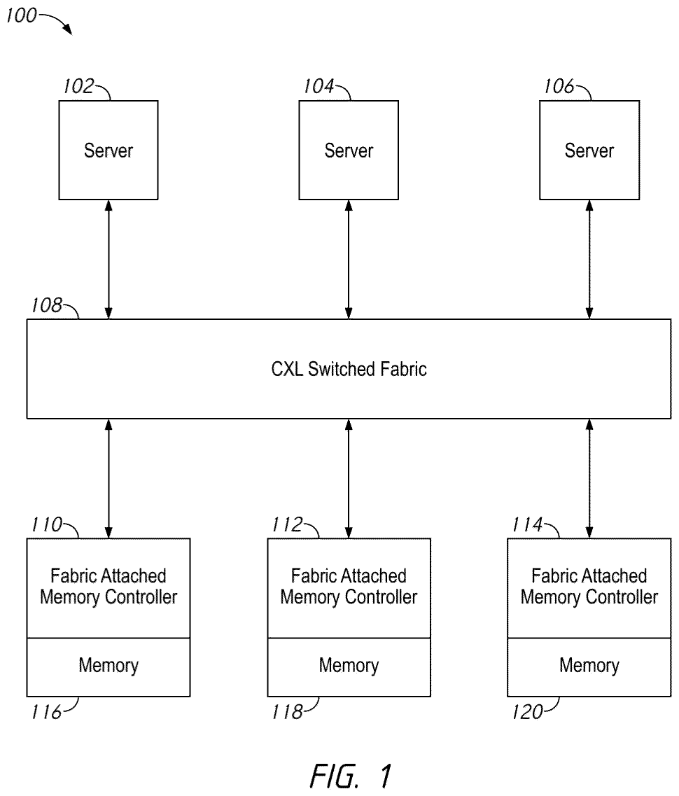

Turning now to the drawings, FIG. 1 illustrates an example system topography 100 for networked communication of virtualized servers. As shown, the system 100 generally includes servers (e.g., servers 102, 104, and 106) which communicate with memory (e.g., memory 116, 118, and 120 associated with fabric attached memory controllers 110, 112, and 144, respectively) via CXL switched fabric 108. CXL switched fabric may be, for example, a memory switching fabric utilizing the CXL protocol. Generally, through the CXL switched fabric 108, each of the servers 102, 104, and 106 may have the ability to access each of the memory 116, 118, and 120 via the fabric attached memory controllers 110, 112, and 114, respectively. In some examples, the memory controllers 110, 112, and/or 114 may be implemented by one or more processors associated with the memory 116, 118, and/or 120. Such one or more processors may be local to, or remote from, the memory 116, 119, and/or 120.

Each of the servers 102, 104, and 106 may be physical servers hosting any number of virtualized servers, such as virtual machines, containers, and the like. In some examples, the servers 102, 104, and/or 106 may be virtualized servers. In some examples, the servers 102, 104, and/or 106 may be traditional physical servers hosting any number of virtualized servers (e.g., VMs and/or containers). In some examples, host side hardware or software may be associated with and/or utilized by each of the servers 102, 104, and 106 to translate from a native network address (e.g., an Ethernet MAC address) to an addressing scheme used by the fabric attached memory (e.g., a flat global address space).

Generally, a data center using the topology shown in FIG. 1 may include physical servers hosting various virtualized servers. The physical servers may generally include processing resources (such as one or more CPUs, GPUs, and the like) and local memory or storage resources.

The CXL switched fabric 108 may interface with both the servers 102, 104, and 106 and fabric attached memory controllers 110, 112, and 114. The CXL switched fabric 108 may generally be a memory fabric complying with the CXL protocol. While described herein as a CXL switched fabric, memory fabric compliant with other similar protocols may be utilized within systems described herein. Servers may interface with the CXL switched fabric using, for example, CXL compliant ports.

The fabric attached memory controllers 110, 112, and 114 may be hardware memory controllers routing packets to the memory 116, 118, and 120, respectively and allowing the servers 102, 104, and 106 to retrieve packets from the memory 116, 118, and 120, respectively. Generally, each of the memory 116, 118, and 120 may include send queues and receive queues for each of the servers 102, 104, and/or 106. For example, the memory 116 may include send queues for each of the servers 102, 104, and 106 and receive queues for each of the servers 102, 104, and 106. Accordingly, the servers 102, 104, and 106 may, in some examples, each access the memory 116, 118, and 120 utilizing the CXL switched fabric 108 and the fabric attached memory controllers 110, 112, and 114. As the system topology shown in FIG. 1 has multiple memory controllers, the system may include multiple packets forwarding engines or other logic responsible for packet forwarding. This increases packet forwarding capacity of the system. Further, dividing network traffic into multiple virtual channels enables low latency communication for small packets and provides quality of service controls such as per virtual channel priorities. With multiple virtual channels, low latency packets don't get delayed indefinitely by bulk data transfer packets.

Though the system in FIG. 1 is shown with three servers 102, 104, and 106, three memory controllers 110, 112, and 114, and three memory locations 116, 118, and 120, other numbers of servers, memory controllers, and/or memory locations may be utilized and/or included in systems using the methods and topologies described herein. In some examples, the systems described herein may include N number of servers, with C number of OSs (e.g., VMs and/or containers) running on the servers, and M number of memory controllers and/or memory locations.

Packets transmitted using the topology shown in FIG. 1 may generally use fewer fields than used in traditional networking protocols (e.g., Ethernet). For example, for communications utilizing the system topology of FIG. 1, the networking packet header and the packet payload may be copied into GFAM and packet movement may be completed by memory-to-memory copy operations. In such examples, as packet routing is done using memory addressing, traditional Ethernet headings (e.g., a VxLAN and Ethernet header) are not needed. Further, because CXL has its own reliability mechanisms, a cyclic redundancy check (CRC) field is also not needed. Accordingly, packets transmitted from OS-to-OS using send and receive queues described herein may include fewer fields (e.g., packet data, any additional headers, TCP/UDP, and/or IPv4/IPv6 fields), reducing processing resources used to communicate such packets.

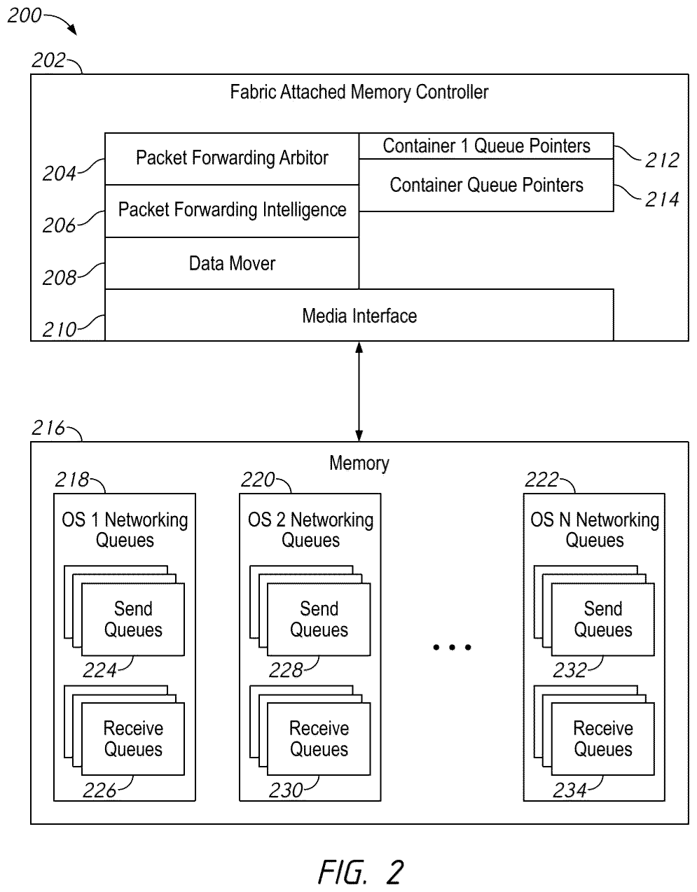

FIG. 2 illustrates an example FAM controller 202 and associated memory 216. The fabric attached memory controller 202 generally communicates with virtualized servers to allow the servers to communicate via the memory 216. For example, the fabric attached memory controller 202 may receive and process data packets from virtualized servers and may copy the data packets to various locations in the memory 216. The fabric attached memory controller 202 may further move data between locations in the memory 216 and/or may allow virtualized servers to access various data packets stored on memory 216.

As shown in FIG. 2, each container may have its own set of send queues and receive queues which may reside in fixed locations on memory. As shown, individual memory locations (e.g., memory 216) may include networking queues (e.g., networking queues 218, 220, and 222) corresponding to different virtualized servers (e.g., OSs such as containers and/or VMs) in communication with the memory location. The send queues and receive queues shown in FIG. 2 may each be associated with a head pointer and tail pointer, which may be utilized by the memory controller 202 and virtualized servers (e.g., servers 102, 104, and 106 of FIG. 1) to send and receive packets using the memory 216. Both the send and receive queues may be first-in, first-out (FIFO) structures.

Generally, for a send queue, the corresponding virtualized server may have both read and write access to the tail pointer (e.g., the virtualized server may update the tail pointer when writing a new packet to the send queues), while the memory controller 202 may have read access to the tail pointer (e.g., to utilize the tail pointer in forwarding packets). For the send queue, the memory controller 202 may have both read and write access to the head pointer of (e.g., to update the head pointer) and the virtualized server may have read access to the head pointer. Conversely, for a receive queue, the memory controller 202 may have read access to the head pointer, while the virtualized server may have read and write access to the head pointer. For the receive queue, the memory controller 202 may have both read and write access to the tail pointer and the host may have read access to the tail pointer.

In some examples, in a multi-device system, send and receive queues may be placed on physically separate devices, with send queues being located physically close to the sender (e.g., a virtualized server sending a packet) and receive queues being located physically close to the receiver (e.g., the virtualized server receiving a packet). Locating send and receive queues in this manner may reduce or minimize latency for the sending and receiving of packets and reduce stalls by placing the data forwarding latency burden on the memory-side devices (e.g., by allowing virtualized servers to perform other tasks in parallel with data transmission). Accordingly, such locating of the send and receive queues may result in quicker packet handoff.

The fabric attached memory controller 202 may be implemented by and/or may be used to implement fabric attached memory controllers described herein, such as the fabric attached memory controllers 110, 112, and 114 shown in FIG. 1. The fabric attached memory controller 202 may include various areas and/or components. For example, the fabric attached memory controller 202 may include a packet forwarding arbiter 204, packet forwarding intelligence 206, a data mover 208, a media interface 210, and container queue pointers 214 (e.g., including pointers for individual container queues, such as container 1 queue pointers 212).

The queue pointer 214 section of the fabric attached memory controller 202 hardware may intercept a read command (such as CXL.mem) for read or write operations targeting the GFAM region starting at the location specified in the control register. Read commands may access on-die pointer information and write to update the on-die pointer information located at the queue pointer 214 portion of the fabric attached memory controller 202.

Arbitration hardware (e.g., the packet forwarding arbiter 204) may actively monitor which send queues have packets which need to be forwarded to a receive queue. The packet forwarding arbiter 204 may generally be architected in such a way that packet forwarding arbitration may be completed with a reasonable amount of hardware.

Packet forwarding intelligence 206 may be fixed logic or a collection of programmable on-die processors that read the heads of active queues, making forwarding decisions based on VLAN configuration rules, VLAN tunneling rules, and other networking configurations. A packet forwarding processor of the packet forwarding intelligence 206 may use data movers (e.g., data mover 208) to accelerate data movement operations by performing bulk data transfers.

In various examples, the fabric attached memory controller 202 may store key information for each container (or VM) utilizing the fabric attached memory controller 202 to access memory 216. Such information may allow packet forwarding intelligence 206 to perform as desired. Such information may include, in various examples, GFAM address location for send and receive buffers, a VxLAN network to which the container belongs, and remote communication properties (e.g., messaging layer security (MLS) header setting or VLAN tunneling properties).

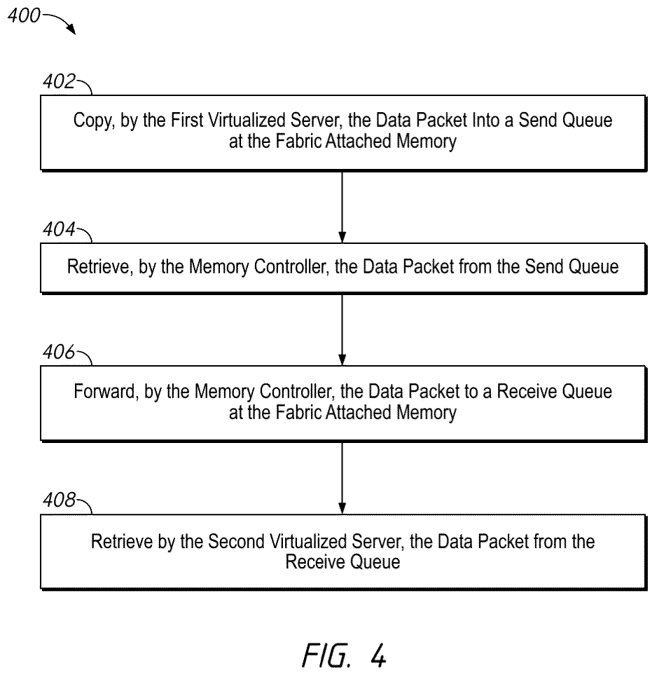

Methods of sending and receiving packets using the architecture and systems shown in FIG. 1 and FIG. 2 are described in more detail with respect to FIGS. 4-6 herein.

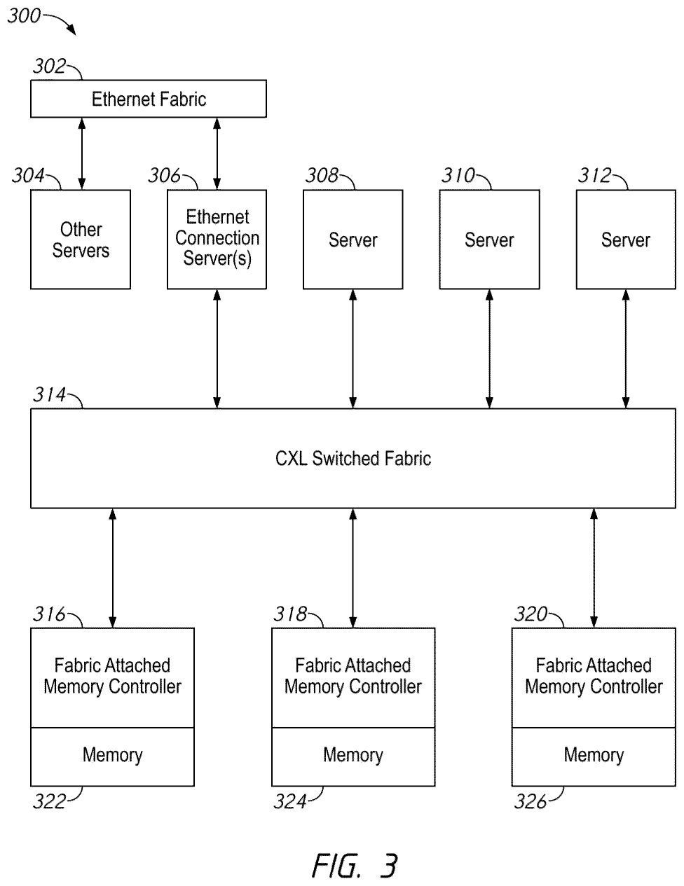

FIG. 3 illustrates an example system topography 300 for networked communication of virtualized servers with capabilities for bridging to remote servers. The architecture described with respect to FIGS. 1 and 2 may generally facilitate intra-rack communications between virtualized servers hosted by servers on a common rack. FIG. 3 shows how such architecture may be extended to communicate with virtualized servers in other racks and/or data centers. As in FIGS. 1 and 2, servers 308, 310, and 312 in a common rack may communicate with CXL switched fabric 314 to send and receive data using memory 322, 324, and 326. Fabric attached memory controllers 316, 318, and 320 interface with the CXL switched fabric 314 to provide access to the memory 322, 324, and 326, respectively.

Additionally, one or more Ethernet connection servers 306 may communicate with the CXL switched fabric 314 to facilitate inter-rack (or inter-data center) communications. For example, an Ethernet connection server 306 may utilize Ethernet fabric 302 to communicate with other servers 304. In various examples, packet forwarding intelligence may send packets to the Ethernet connection server 306 (or to a container at the Ethernet connection server 306), where the Ethernet connection server 306 is dedicated to interfacing with Ethernet networking through the Ethernet fabric 302. The Ethernet connection server 306 may also forward packets received from other servers 304 via the Ethernet fabric 302 to the GFAM connected servers 308, 310, and 312 using the GFAM send queues.

Though the system in FIG. 3 is described as using Ethernet networking protocols, other traditional networking protocols, such as InfiniBand, may be utilized to bridge other servers to a rack or data server utilizing the GFAM protocols described herein.

FIG. 4 illustrates an example method 400 for networked communication between virtualized servers. The operations of the method 400 may be performed using any combination of virtualized server utilizing the GFAM architecture described herein. Though the method 400 is described with respect to the server 102 and the server 104, any of the servers 102, 104 and/or 106 of FIG. 1 and/or the servers 308, 310, and/or 312 may be used to perform the operations of the method 400. Similarly, while the method 400 is described as accessing memory 116 using a fabric attached memory controller 110, and of the memory or memory controllers described herein may be utilized in performing the method 400.

At block 402, the first virtualized server 102 copies a data packet into a send queue at the GFAM 116. Generally, the first virtualized server 102 may copy the packet into a send queue (e.g., send queue 224 shown in FIG. 2) associated with the first virtualized server and may communicate with an associated memory controller 110 to copy the data packet to the send queue. For example, the first virtualized server 102 may communicate with the memory controller 110 to read queue pointers associated with the send queue. Using the retrieved queue pointers, the first virtualized server 102 may determine whether there is space in the send queue for the new data packet. Where there is space in the send queue, the first virtualized server 102 may then transfer the packet to the send queue. After transferring the packet to the send queue, the first virtualized server 102 may communicate with the memory controller 110 to update the tail pointer of the send queue to reflect the location of the packet transferred to the send queue.

The memory controller 110 retrieves the data packet from the send queue at block 404. For example, the packet forwarding arbiter may monitor the send queue and determine that the packet has been added to the send queue and should be forwarded to the receive queue. At block 406, the memory controller 110 forwards the data packet to a receive queue at the GFAM 116. For example, packet forwarding intelligence of the memory controller 110 may read the head of the send queue and forward the packet to the correct receive queue based on, for example, VLAN configuration rules, VLAN tunneling rules, and other networking configuration. For example, the packet forwarding intelligence may access information such as the GFAM address location for the receive queue, a VLAN network to which the second virtualized server 104 belongs, and or header settings and VLAN tunneling properties associated with the second virtualized server 104 to determine how to forward the data packet to the appropriate receive queue. In some examples, the memory controller 110 may utilize a data mover to accelerate data movement operations (e.g., by performing bulk data transfers).

The second virtualized server 104 retrieves the data packet from the receive queue at block 408. The second virtualized server 104 may, in some examples, continuously poll the receive queue to determine whether there are data packets in the receive queue to be retrieved by the second virtualized server 104. For example, the second virtualized server 104 may read the queue pointers of the receive queue associated with the second virtualized server 104 to make such a determination. The second virtualized server 104 may then utilize the queue pointers to retrieve the data packet from the queue and then may update the head pointer of the receive queue to indicate that the data packet has been read from the receive queue.

Using the method 400, the first virtualized server 102 and the second virtualized server 104 may communicate data using the send and receive queues located at the shared GFAM locations, such that the first virtualized server 102 and the second virtualized server 104 do not need to communicate via Ethernet or other traditional networking protocols.

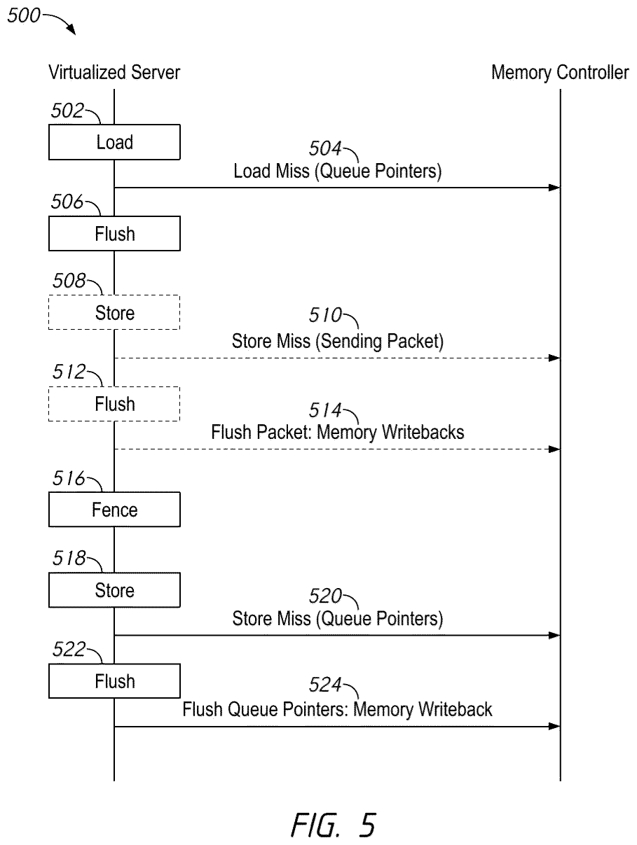

FIG. 5 illustrates example operations 500 for a virtualized server to send a data packet using the networked communication techniques described herein. The example operations 500 may be performed by a virtualized server utilizing the GFAM architecture described herein, such as any of the servers 102, 104, or 106 in FIG. 1. Though any virtualized server described herein may perform the operations 500 to send data packets, the operations 500 are described as being performed, for example, by the server 102 in communication with the fabric attached memory controller 110 to send a packet using a send queue located at the memory 116.

At a load operation 502, the virtualized server 102 reads send queue pointers by reading from the appropriate location in the memory 116. The memory controller 110 may intercept the read and deliver the pointer location without reading the media for the location. In some examples, the send queue pointers may reside in a reserved portion of memory 116 where packet forwarding intelligence and data movement hardware are located on a chip other than the memory controller 110. The load operation 502 results in a load miss 504 to the memory controller.

At operation 506, a flush operation is performed when the memory 116 is configured as cacheable. For example, since the processor cache may contain an inconsistent snapshot of the data, the flush operation 506 is performed so that any subsequent access to the same location re-reads the hardware to get the most up-to-date data.

If there is room is the send queue for the packet (which may be determined by the server 102 based on the load operation 502), processors of the virtualized server 102 perform a series of stores 508 or direct memory access (DMA) transfers to the send queues, resulting in a store miss 510 being communicated to the memory controller 110 to send the packet. The push the data to the GFAM buffer, a series of flush operations 512 are performed if the memory is cacheable, resulting in a flush packet 514 being communicated to the memory controller 110.

A fence operation 516 performed by the virtualized server 102 may be performed to ensure that all previously issued flushes have pushed data to the memory controller 110. After the fence operation 516, a store operation 518 is performed by the virtualized server 102 to update the tail pointer for the send queue. The store operation 518 causes the processors of the virtualized server 102 to issue a store miss 520 to the queue pointer location. The memory controller 110 intercepts the read and returns data to the virtualized server 102 giving the current state of the queue.

A flush operation 522 is performed by the virtualized server 102 to inform the memory controller 110 of the updated tail of the send queue by flushing the data. As a result of the flush operation 522, a flush of the queue pointers 524 to the memory controller 110 causes the memory controller 110 to intercept and update the queue pointer.

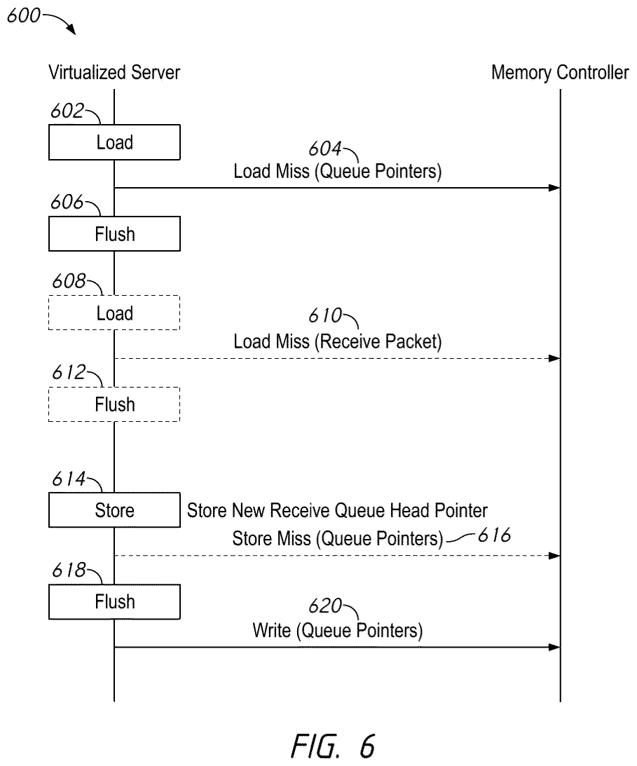

FIG. 6 illustrates example operations 600 for a virtualized server to receive a data packet using the networked communication techniques described herein. The example operations 600 may be performed by a virtualized server utilizing the GFAM architecture described herein, such as any of the servers 102, 104, or 106 in FIG. 1. Though any virtualized server described herein may perform the operations 600 to receive data packets, the operations 600 are described as being performed, for example, by the server 102 in communication with the fabric attached memory controller 110 to receive a packet using a receive queue located at the memory 116.

Generally, the virtualized server 102 (and other virtualized servers) may periodically poll each receive queue associated with the virtualized server to determine whether the receive queue contains packets waiting in the receive queue to be received by the virtualized server 102. To determine whether there are packets in the receive queue, the virtualized server 102 reads the queue pointers of the receive queue using a load operation 602. The load instruction causes a processor of the virtualized server 102 to issue a cache line miss request 604, which is intercepted by the memory controller to provide the most up-to-date pointer data. Alternatively, in some examples, an interrupt or other event message supported by the memory fabric protocol can notify the virtualized server 102 of received packets. In such examples, a host identifier and container identifier associated with the virtualized server 102 are recorded with each receive queue to correctly direct such notifications. Notifications may trigger when the queue exceeds a certain capacity threshold, or after a timeout, allowing more packets to be enqueued at the receive queue.

A flush operation 606 is performed by the virtualized server 102. To ensure that the next load to the location re-reads, the cache line is flushed. At a load operation 608, the virtualized server 102 uses the pointer information to read the packet at the head of the receive queue using load instructions to pull the packet into the processor cache. As a result of the load operation 608, the virtualized server 102 issues a load miss 610 to the memory controller 110 to receive the packet.

The virtualized server 102 performs a flush operation 612 to ensure that the next load to the location re-reads from the GFAM media. During the flush operation 612, invalidation operations are issued for all cache lines read during the load operation 608. Using a store operation 614, the virtualized server 102 updates the head pointer for the receive queue by issuing a store miss 616 to the memory controller 110. The virtualized server 102 then performs a flush operation 618 to push data out of the processor cache. The memory controller 110 intercepts the write 620 and updates the queue pointer information stored at the memory controller 110 accordingly.

In accordance with the above description, the networked communication techniques described herein may provide various advantages when compared to traditional networking protocols. For example, the systems described herein may allow data centers which desire to deploy memory pooling (e.g., through the CXL protocol) to further reduce costs by using the GFAM for server-to-server networking. Such cost reduction may result from the reduction in NICs used in a data center. Further, the number of traditional networking switches can be reduced, as most communication within a rack can be accomplished using the CXL GFAM.

The networked communication techniques described herein may further improve use of memory by containers, through use of a virtual memory page system handled by the operating system and computer hardware. The techniques further avoid limitations of single root input/output virtualization SR-IOV, which generally limit the number of containers on a server to 256. For example, containers may interface directly with networking queues, bypassing SR-IOV. The techniques described herein may further require fewer CPU resources when compared to traditional networking protocols. This is true even in highly virtualized environments, such as cloud data centers implementing containers as a service. Because each container has its own pointer interface, each container may send and receive networking packets without making a system call to the server's primary OS, increasing the number of containers which may be hosted on a physical server by reducing communications bottlenecks from containers on the same physical server.

The foregoing description has a broad application. For example, while examples disclosed herein may focus on central communication system, it should be appreciated that the concepts disclosed herein may equally apply to other systems, such as a distributed, central or decentralized system, or a cloud system. For example, the flight planner 120 and/or other components in the distribution system (e.g., distribution center inventory and computing systems) may reside on a server in a client/server system, on a user mobile device, or on any device on the network and operate in a decentralized manner. One or more components of the systems may also reside in a virtual machine (VM), container, or other OS in a virtualized computing environment. Accordingly, the disclosure is meant only to provide examples of various systems and methods and is not intended to suggest that the scope of the disclosure, including the claims, is limited to these examples.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method of transmitting a data packet from a first virtualized server to a second virtualized server, the method comprising:
copying, by the first virtualized server, the data packet into a send queue associated with the first virtualized server, wherein the send queue is located at a fabric attached memory, wherein the fabric attached memory is accessible by the first virtualized server and the second virtualized server;
retrieving, by one or more processors associated with the fabric attached memory, the data packet from the send queue;
forwarding, by the one or more processors, the data packet to a receive queue associated with the second virtualized server, wherein the receive queue is located at the fabric attached memory; and
retrieving, by the second virtualized server, the data packet from the receive queue.

2. The method of claim 1, wherein the fabric attached memory is accessible by the first virtualized server and the second virtualized server using a compute express link (CXL) protocol.

3. The method of claim 1, wherein the first virtualized server and the second virtualized server are containers.

4. The method of claim 3, wherein the first virtualized server is hosted at a first physical server located at a rack, wherein the second virtualized server is hosted at a second physical server located at the rack.

5. The method of claim 1, further comprising;
determining, by the second virtualized server that the data packet is in the receive queue based on a monitoring of the receive queue, wherein the data packet is retrieved from the receive queue by the second virtualized server based on the determination that the data packet is in the receive queue.

6. The method of claim 1, wherein copying, by the first virtualized server, the data packet into the send queue comprises updating a tail pointer associated with the send queue, wherein retrieving, by the one or more processors, the data packet from the send queue comprises using the updated tail pointer to retrieve the data packet, wherein the send queue is a first-in-first-out queue associated with the first virtualized server.

7. The method of claim 1, wherein retrieving, by the second virtualized server, the data packet from the receive queue comprises updating a head pointer associated with the receive queue.

8. A fabric attached memory controller interfacing with a compute express link (CXL) switched memory fabric and at least a first virtualized server and a second virtualized server in communication with the CXL switched memory fabric, the fabric attached memory controller comprising:
a packet forwarding arbiter configured to monitor a send queue associated with the first virtualized server at a global fabric attached memory (GFAM) to determine that the send queue contains a packet to be sent to the second virtualized server; and
packet forwarding intelligence configured to utilize stored information about the second virtualized server to forward the packet to a receive queue associated with the second virtualized server at the GFAM.

9. The fabric attached memory controller of claim 8, wherein the first virtualized server and the second virtualized server are containers.

10. The fabric attached memory controller of claim 9, wherein the first virtualized server is hosted at a first physical server located at a rack, wherein the second virtualized server is hosted at a second physical server located at the rack, wherein the CXL switched memory fabric is connected to the first physical server and the second physical server.

11. The fabric attached memory controller of claim 8, wherein the fabric attached memory controller stores pointer information for the send queue and the receive queue.

12. The fabric attached memory controller of claim 11, wherein the packet forwarding intelligence is further configured to update the pointer information for the receive queue after forwarding the packet to the receive queue.

13. The fabric attached memory controller of claim 8, wherein the GFAM further includes a second receive queue corresponding to the first virtualized server and a second send queue corresponding to the second virtualized server.

14. A data center comprising:
a fabric attached memory;
a first virtualized server located at a first physical host, wherein the first virtualized server is configured to copy a data packet into a send queue associated with the first virtualized server, wherein the send queue is located at the fabric attached memory;
one or more processors associated with the fabric attached memory, wherein the one or more processors are configured to retrieve the data packet from the send queue and to forward the data packet to a receive queue at the fabric attached memory; and
a second virtualized server located at a second physical host and associated with the receive queue, wherein the second virtualized server is configured to retrieve the data packet from the receive queue.

15. The data center of claim 14, wherein the first virtualized server and the second virtualized server are containers.

16. The data center of claim 14, wherein the first virtualized server, the one or more processors, and the second virtualized server are each connected to a switched memory fabric.

17. The data center of claim 16, wherein the switched memory fabric uses a compute express link (CXL) protocol.

18. The data center of claim 16, further comprising an Ethernet connection server connected to the switched memory fabric, the Ethernet connection server facilitating packet communication with other servers outside of the data center using an Ethernet protocol.

19. The data center of claim 14, wherein the second virtualized server is further configured to determine that the data packet is in the receive queue based on a monitoring of the receive queue, wherein the data packet is retrieved from the receive queue by the second virtualized server based on the determination that the data packet is in the receive queue.

20. The data center of claim 14, wherein the first virtualized server is further configured to update a tail pointer associated with the send queue after copying the data packet into the send queue, wherein the one or more processors are configured to retrieve the data packet from the send queue using the updated tail pointer to retrieve the data packet.
